(19) United States
(12) Patent Application Publication
(10) Pub. No.: US 2019/0041536 A1
(43) Pub. Date: Feb. 7, 2019

(54) Interior Seismic Data Generator

(71) Applicant: LANDMARK GRAPHICS CORPORATION, Houston, TX (US)

(72) Inventors: Travis St. George Ramsay, Hockley, TX (US); Jessey Mathias Lomask, Houston, TX (US)

(21) Appl. No.: 16/069,808

(22) PCT Filed: Mar. 8, 2016
(86) PCT No.: PCT/US2016/021303

§ 371 Date: Jul. 12, 2018

(51) Int. Cl. G01V 1/50; G01V 1/30

(52) U.S. Cl. CPC G01V 1/50; G01V 1/306; G01V 2210/1299; G01V 2210/74; G01V 2210/57; G01V 2210/624; G01V 2210/665; G01V 2210/1429

(57) ABSTRACT

A system and method are provided for creating interior seismic data between measurements of actual seismic data. The interior seismic data may be created using processes for approximating or constructing seismic data between times the actual seismic data is sampled. In some aspects, the interior seismic data may be approximated by determining a rate of change in the seismic data between at least two measurements of seismic data over time. In other aspects, the interior seismic data may be created by constructing an intermediate state of the formation between the times corresponding to at least two measurements of the seismic data based on a trend associated with the measurements. In additional aspects, a Gaussian white noise may be applied to the measurements to yield an array of equally probable predictions for the intermediate state of the property.

### TECHNICAL FIELD

The present disclosure relates generally to seismic measurements for wellbores, and, more particularly, although not necessarily exclusively, to creating seismic data at instances in elapsed time between seismic data sampling intervals.

### BACKGROUND

In hydrocarbon exploration, seismic energy may be generated and transmitted into formations positioned in an area of interest. Seismic waves may be reflected or refracted off the formations and recorded by acoustic receivers positioned in or near the wellbore, as well as surface and marine acquisition at far offsets. The seismic waves reflected from the formations may be sampled as seismic data and used to estimate the properties of the formations in the area of interest. For example, information including the travel time of the seismic waves from the formations to the receivers and the velocity of the seismic waves may be extracted from the seismic data and used to generate images indicative of formation assemblages.

### BRIEF DESCRIPTION OF THE DRAWINGS

FIG. 1 is a cross-sectional schematic diagram depicting an example of a wellbore environment for acquiring data to generate interior seismic data according to an aspect of the present disclosure.

FIG. 2. is a cross-sectional schematic diagram depicting an example of a marine environment for acquiring data to generate the interior seismic data according to an aspect of the present disclosure.

FIG. 3 is a block diagram depicting a system for creating interior seismic data according to an aspect of the present disclosure.

FIG. 4 is a flow chart of a process for creating and using interior seismic data according to an aspect of the present disclosure.

FIG. 5 is a flow chart of sub-processes for creating interior seismic data according to an aspect of the present disclosure.

FIG. 6 is a graph of an example of interior seismic data generated using an approximation sub-process according to an aspect of the present disclosure.

FIG. 7 is a graph of an example of interior seismic data generated using a multi-equi-probable realization construction sub-process according to an aspect of the present disclosure.

### DETAILED DESCRIPTION

Certain aspects and examples of the present disclosure relate to creating interior seismic data between sampling intervals of actual seismic data to construct images of subterranean formations at instances of time when no actual seismic data was sampled. The seismic data may be four-dimensional seismic data corresponding to the same area of subterranean formation being successively sampled using sensors of a seismic tool positioned in a wellbore or at far lateral offsets. The interior seismic data may be created using one or more processes for approximating or constructing seismic data between, or interior to, the times the actual seismic data is sampled. The interior seismic data may be created based on time-dependent rock properties of the formations corresponding to the inverted actual seismic data.

In some aspects, the interior seismic data may be approximated by considering a rate of change in the seismic data between at least two samples of seismic data over time. The rate of change may be applied to the earlier of the two samples to determine the seismic data at a time between times associated with the two samples. In other aspects, the interior seismic data may be created by constructing an intermediate state of the formation between the times corresponding to at least two samples of the seismic data. The intermediate state may be determined by identifying a trend associated with the seismic data samples and interpolating or otherwise predicting the state of the seismic data at a time between the acquired seismic data samples corresponding to the trend. In some examples, the trend may be based on both the spatial and temporal attributes of the properties of the formations during the observed times. For example, the relationship between a property of an area of the formation (e.g., the position of the rocks in the formation) and the time associated with the samples of the seismic data corresponding to the property may be the same as the relationship between the same property of the same area of the formation at a different time. The differences in the relationship may be observed to determine a trend and an intermediate state of the property of the formation during a time between the sample times using the identified trend.

In additional aspects, the interior seismic data may be similarly created by applying Gaussian white noise to a linear prediction of the seismic data samples. The Gaussian white noise may represent uncertainties in changes to the property over time to yield an array of equally probable predictions for the intermediate state of the property. In some aspects, the predictions may be compared to a simulation of fluid flow through the area of the formations using petro-elastic modeling techniques and selecting the prediction closest to the simulation as the interior seismic data.

Interior seismic data may be useful to provide additional information regarding subterranean formations without requiring frequent sampling of seismic data. For example, interior seismic data may be used to illustrate changes in the formations corresponding to the seismic data in intervals of days or weeks, while the actual measurements are sampled only monthly or yearly. In this respect, savings may be realized in operational costs corresponding to the acquisition of the seismic data and replacement and maintenance costs of seismic tools, sensors, wave generators due to their frequent use.

These illustrative examples are provided to introduce the reader to the general subject matter discussed here and are not intended to limit the scope of the disclosed concepts. The following sections describe various additional aspects and examples with reference to the drawings in which like numerals indicate like elements, and directional descriptions are used to describe the illustrative examples but, like the illustrative examples, should not be used to limit the present disclosure. The various figures described below depict examples of implementations for the present disclosure, but should not be used to limit the present disclosure.

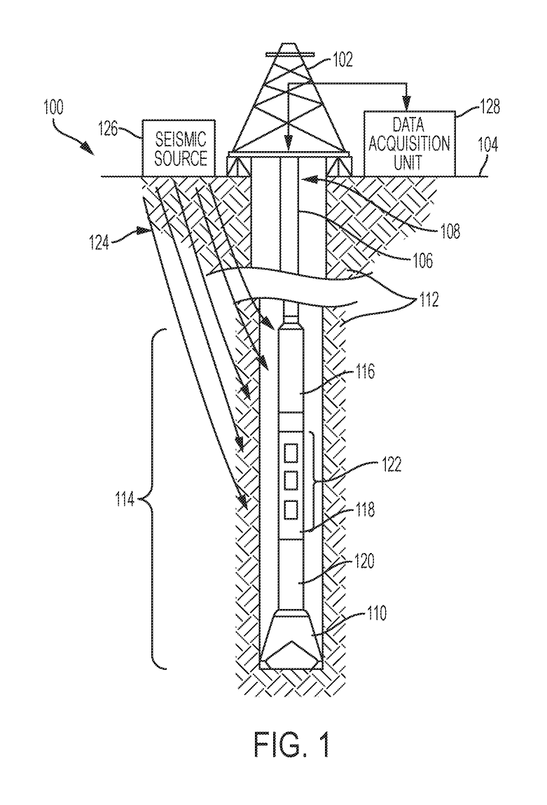

Various aspects of the present disclosure may be implemented in various environments. FIG. 1 is a cross-sectional schematic diagram depicting an example of a wellbore environment 100 for acquiring data usable by a system according to some aspects of the present disclosure. The wellbore environment 100 includes a derrick 102 positioned at a surface 104. The derrick 102 may support components of the wellbore environment 100, including a drill string 106. The drill string 106 may include segmented pipes that extend below the surface 104 in a wellbore 108. The drill string 106 may transmit drilling fluid (or drilling mud) necessary to operate a drill bit 110 positioned at the end of the drill string 106. The mud transmitted by the drill string 106 may provide the torque necessary to operate the drill bit 110. The weight of the drill string 106 may provide an axial force on the drill bit 110 that, together with the rotation of the drill bit 110, may aid in drilling the wellbore 108 from the surface 104 through subterranean formations 112 in the earth.

The drill string 106 includes a bottom hole assembly 114 positioned on the drill string 106 uphole of the drill bit 110. The bottom hole assembly 114 includes a combination of various components, such one or more drill collars 116, a seismic tool 118, and a downhole motor assembly 120 for housing a motor for the drill bit 110. In some aspects, the measurement devices may include an array of seismic sensors 122, such as geophones. The seismic sensors 122 may operate in response to seismic waves 124 generated by a seismic source 126 positioned at the surface 104 proximate to the wellbore 108. The seismic source 126 may generate seismic energy to form the seismic waves 124 that may be transmitted from the surface 104 through the formations 112 adjacent to the wellbore 108. Non-limiting examples of a seismic source 126 may include an air gun, a plasma sound source, a weight-drop truck, one or more explosive devices, an electromagnetic pulse (“EMP”) energy source, and a seismic vibrator. Some of the seismic waves 124 generated by the seismic source 126 may be reflected or refracted by the formations 112 and sampled by the seismic sensors 122 positioned on the seismic tool 118.

The samples received by the seismic sensors 122 of the seismic tool 118 may be recorded and used by a data acquisition unit 128 at the surface 104 to acquire seismic data to provide information about the formations 112 adjacent to the wellbore 108. In some aspects, the seismic sensors 122 may be configured to sample the seismic waves 124 reflected or refracted from the formations 112 at predetermined intervals of time. In additional and alternative aspects, the seismic source 126 may be configured to generate and transmit the seismic waves 124 at the predetermined intervals. In one example, the seismic data 304 may be generated by the seismic sensors 122 and stored in the data acquisition unit 128 once every month. In other examples, the seismic data 304 may be generated and stored once every three months, once every six months, once a year, etc.

In some aspects, the samples received by the seismic sensors 122 may be stored in a storage device or memory unit positioned downhole in the bottom hole assembly 114 and subsequently retrieved for analysis by the data acquisition unit 128. In other aspects, the seismic tool 118 may be communicatively coupled to the data acquisition unit 128 by suitable wired or wireless means to collect data samples from the sensors of the seismic tool 118. In some aspects, the data acquisition unit 128 may be communicatively coupled to or otherwise include storage means for providing the seismic data to a system according to aspects of the present disclosure to create interior seismic data. Although only one data acquisition unit 128 is shown, the wellbore environment 100 may include any number of units or devices for acquiring information from the seismic tool 118. Also, though certain devices are shown as positioned on the surface 104 (e.g., the seismic source 126, the data acquisition unit 128) and others are shown as positioned downhole in the wellbore 108 (e.g., the seismic tool 118), any combination for the position of the devices may be possible to acquire seismic data without departing from the scope of the present disclosure.

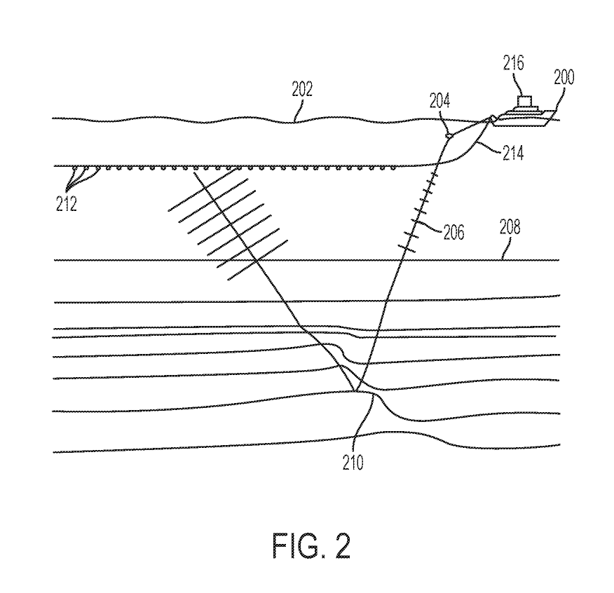

FIG. 2 is a cross-sectional schematic diagram depicting an example of a marine environment for acquiring seismic data according to an aspect of the present disclosure. A seismic vessel 200 is positioned on a surface 202 of the ocean. The seismic vessel 200 may tow one or more seismic sources 204, such as an impulse source or a vibratory source. The seismic sources 204 may transmit seismic waves 206 through the ocean floor 208. The seismic waves 206 may be reflected or refracted off subterranean formations 210 below the ocean floor 208 and received by an array of seismic sensors 212, such as hydrophones, trailing behind the seismic vessel 200 on one or more streamers 214. In some aspects, the streamers 214 may include electrical or fiber-optical cabling for connecting the array of sensors 212 to seismic equipment on the ship 100, including a data acquisition unit 216. The sensors 212 may measure the reflections of the seismic waves 124 and transmit the measurements through the streamers 214 for storage in the data acquisition unit 216.

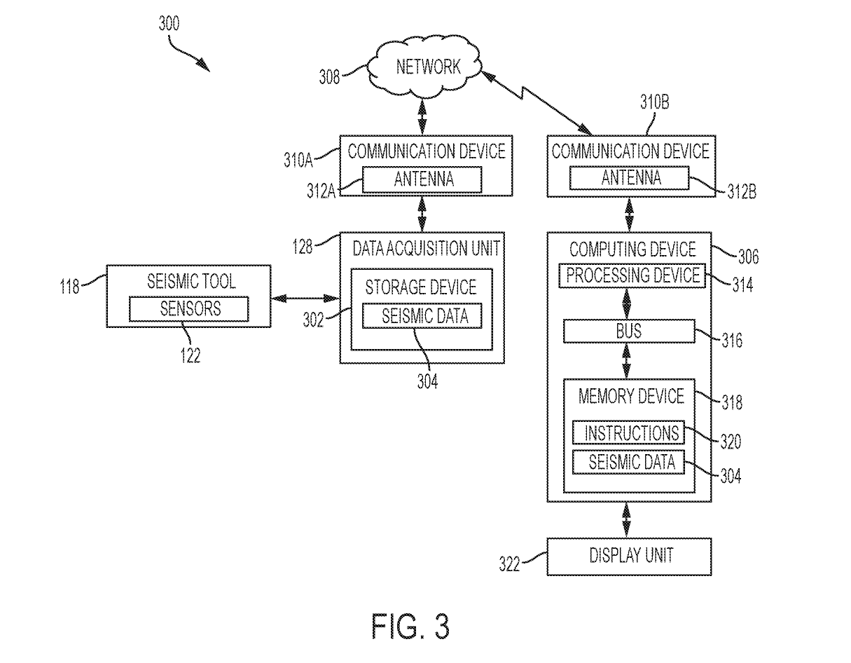

FIG. 3 is a block diagram depicting a system 300 for creating interior seismic data according to an aspect of the present disclosure. The system 300 includes the data acquisition unit 128 of FIG. 1. The data acquisition unit 128 is coupled to the seismic tool 118 of FIG. 1. The seismic tool 118 may include one or more of the seismic sensors 122 for detecting seismic waves generated by a seismic source (e.g., the seismic source 126 of FIG. 1) and reflected or refracted off subterranean formations adjacent to a wellbore (formations 112 adjacent to the wellbore 108 of FIG. 1) for acquiring images of the formations. Although the system is described with respect to components of the wellbore environment 100 of FIG. 1, other suitable means for creating interior seismic data may be employed without departing from the scope of the present disclosure. For example, the system 300 may include the data acquisition unit 216 and a seismic tool including the array of seismic sensors 212 of FIG. 2.

The data acquisition unit 128 may receive the samples from the sensors 122 of the seismic tool 118 and store the sample information in a storage device 302. Non-limiting examples of the storage device 302 may include one or more databases, memory devices, or other storage means for storing the information received from the seismic tool 118. The storage device 302 may store the sample information generated from the seismic tool as seismic data 304. In some aspects, the seismic data 304 may include raw information from the sensors 122 of the seismic tool 118. In other aspects, the seismic tool 118 or an intermediate device between the seismic tool 118 and the data acquisition unit 128 may include processing means for processing some or all of the samples received by the sensors 122, prior to transmitting the seismic data 304 to the data acquisition unit 128 for storage.

The system 300 includes a computing device 306 that is communicatively coupled to the data acquisition unit 128. In some aspects, the computing device 306 may be positioned in a remote location away from a wellbore environment. In some aspects, the 304 may be transmitted from the data acquisition unit 128 to the computing device 306 via a network 308. The data acquisition unit 128 and the computing device 306 may be coupled to, or include, respective communication devices 310A, 310B. The communication devices 310A, 310B includes or is coupled to an antenna 312A, 3128, respectively for transmitting and receiving information via the network 308. Although the system 300 describes transmitting information via the network 308, other suitable means may be employed for transmitting information between the data acquisition unit 128 and the computing device 306, including but not limited to using a wired connection, portable storage devices, etc., without departing from the scope of the present disclosure.

The computing device 306 may include a processing device 314, a bus 316, and a memory device 318. The processing device 314 may execute one or more operations for creating interior seismic data using the seismic data 304 received from the data acquisition unit 128. The processing device 314 may execute one or more processes for creating the interior seismic data. The processing device 314 may execute instructions 320 stored in the memory device 318 to perform the operations. The processing device 314 may include one processing device or multiple processing devices. Non-limiting examples of the processing device 314 may include a field-programmable gate array (“FPGA”), an application-specific integrated circuit (“ASIC”), a microprocessor, etc. The memory device 318 may include any type of storage device that retains stored information when powered off. Non-limiting examples of the memory device 318 may include electrically erasable and programmable read-only memory (“EEPROM”), a flash memory, or any other type of non-volatile memory. In some examples, at least a portion of the memory device 318 may include a computer-readable medium from which the processing device 314 can read the instructions 320. A computer-readable medium may include electronic, optical, magnetic, or other storage devices capable of providing the processing device 314 with computer-readable instructions or other program code. Non-limiting examples of a computer-readable medium include, but are not limited to, magnetic disks, memory chips, ROM, random-access memory (“RAM”), an ASIC, a configured processor, optical storage, or any other medium from which a compute processor can read the instructions 320. The instructions 320 may include processor-specific instructions generated by a compiler or an interpreter from code written in any suitable computer-programming language, including, for example, C, C++, C#, etc.

In some examples, the instructions 320 may include one or more equations usable for creating the interior seismic data. For example instructions 320 may include the following expansion equations for creating interior seismic data corresponding to time-dependent rock properties at an interior instance of time between two intervals of sampled seismic data:

F(t₂ᵢ₊₁)=F(t₂ᵢ)+F′(t₂ᵢ)(t₂ᵢ₊₁−t₂ᵢ) . . . , [Equation 1]

where F represents a function of seismic data, t represents a sample time, i represents a sample interval number corresponding to the sample time, and F′ represents a rate of change in the seismic data. In additional examples, Equation 1 may include functions of seismic data at additional time intervals corresponding to a Taylor series expansion of the continuous rock property of the formations 112. In further examples, the instructions 320 may include additional variations of Equation 1, including, but not limited to, the following equation for approximating the rate of change of seismic data F between time measurement intervals t₂ᵢ and t2₁₊₂:

$${F}^{′} ( {t}_{2 i} ) = \frac{F ( {t}_{2 i + 2} ) - F ( {t}_{2 i} )}{{t}_{2 i + 2} - {t}_{2 i}} \qquad [ Equation 2 ]$$

The instructions 320 may also include equations for creating the interior seismic data by constructing the interior seismic data from trends of observed seismic data in the time domain and the space domain. For example, the following equation may be used to create a spatio-temporal variogram describing the variance of data between two samples of the seismic data 304 in the space and time domains:

$$γ ( x , t ) = \frac{1}{2 n} \sum {[ Z ( {x}_{i} , {t}_{i} ) - Z ( {x}_{j} , {t}_{j} ) ]}^{2} … , \qquad [ Equation 3 ]$$

where Z is a random function depending on time and space, simultaneously, corresponding to seismic data 304 sampled by the seismic tool 118, the i index is related to an observation of seismic data 304 at a fixed location in space x and time t, and the j index is related to a second observation of the seismic data 304 at a different location x+Δx and a different time t+Δt.

In some aspects, an unbiased linear prediction of the random function Z may be identified using interpolation methods to determine a trend corresponding to the random functions. The following equation may be used to determine a prediction z at a time and position in space at a point between the sample intervals of seismic data 304 according to the trend:

z(x₀, t₀)=m₀^{T}β+c₀^{T}Cₙ⁻¹(\tilde{z}−Mβ), [Equation 4]

where z is a realization of the random function Z in Equation 3, M is a design matrix of predictor variables at the location of an observation of the seismic data 304 at a first location, m₀ is a vector of predictors at the first location, Cₙ is a covariance matrix of the residuals (e.g., the difference between the observed values and the predicted values) at each location corresponding to the seismic data 304, c₀ is a vector of covariance between the observation and prediction residuals, and \tilde{z} is the vector of observations at locations z(xᵢ,tᵢ).

In some aspects, the instructions 320 may also include the equations for computing a space-time covariance for the interior seismic data in space s, time t, and combined space-time st processes. The processes may be governed by a space-time anisotropy ratio for comparing changing in the spatial location of the formations to the elapsed time between the sampling of the seismic data 304:

C(Δx, Δt)=Cₛ(Δx)+Cₜ(Δt)+Cₛₜ(\sqrt{x²+(αΔt)²}), [Equation 5]

where α corresponds to a zonal anisotropy ratio that may vary depending on the amount of variation in space to time. The variation in space to time may provide the ratio a unit of velocity. In some aspects, the velocity associated with the zonal anisotropy ratio may correspond to a propagation velocity of the seismic waves sampled by the sensors for generating the seismic data 304.

The instructions 320 may also include the following equation for verifying the accuracy of the interior seismic data:

$$\sum \vert \frac{u Δ t}{Δ {x}_{i}} \vert \leq 1 , \qquad [ Equation 6 ]$$

where Δt corresponds to an elapsed time between sampling of the seismic data 304, Δx corresponds to the changes in spatial location of the formation properties associated with the samples of seismic data 304, and u corresponds to the velocity of the seismic waves sampled by the seismic tool 118. In some aspects, the zonal anisotropy ratio α in Equation 5 may be equal to the velocity u in Equation 6, and Δx in Equation 6 may correspond to Δx in Equation 5, and Δt in Equation 6 is N times the upper bound of the numerical model time increment Δt of Equation 5, where N>1.

In some aspects, the instructions 320 may include computer-programming code for causing the processing device 312 to generate one or more user interfaces. In some examples, the user interfaces may include selection tools (e.g., input selection options) to control all or a portion of the process of creating interior seismic data. In additional aspects, the instructions 320 may include code for causing the processing device 312 to generate images or animations associated with the information received or generated by the computing device 306 to be displayed on a display unit 322. In some examples, the computing device 306 may create interior seismic data at multiple times between sampling intervals of seismic data 304. The computing device 306 may store the interior seismic data with the seismic data 304 in the memory device 318. The memory device 318 may include instructions 320 to display the seismic data 304 and the created the interior data in order of time at a rate to generate an animation of changes to formations corresponding to the seismic data over time. The display unit 322 may include any CRT, LCD, OLED, or other device for displaying interfaces generated by the processing device 314.

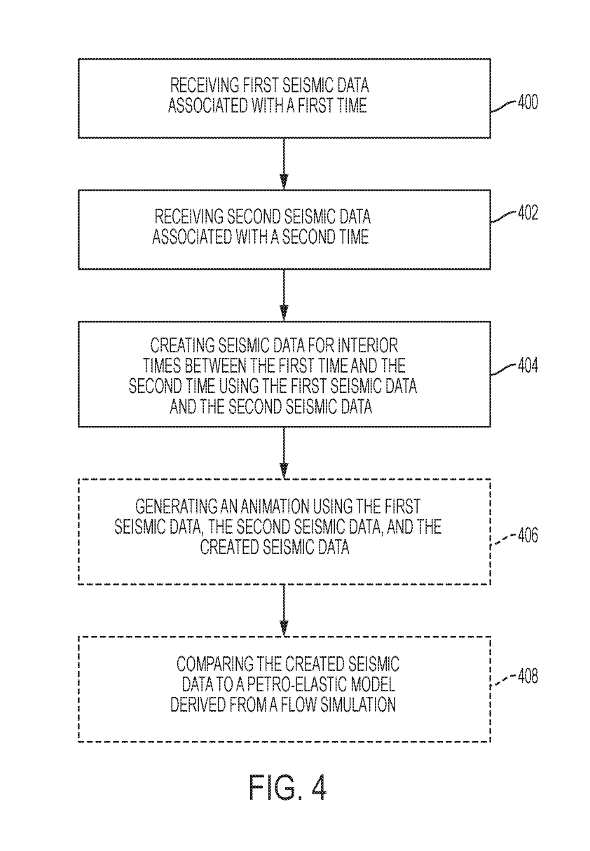

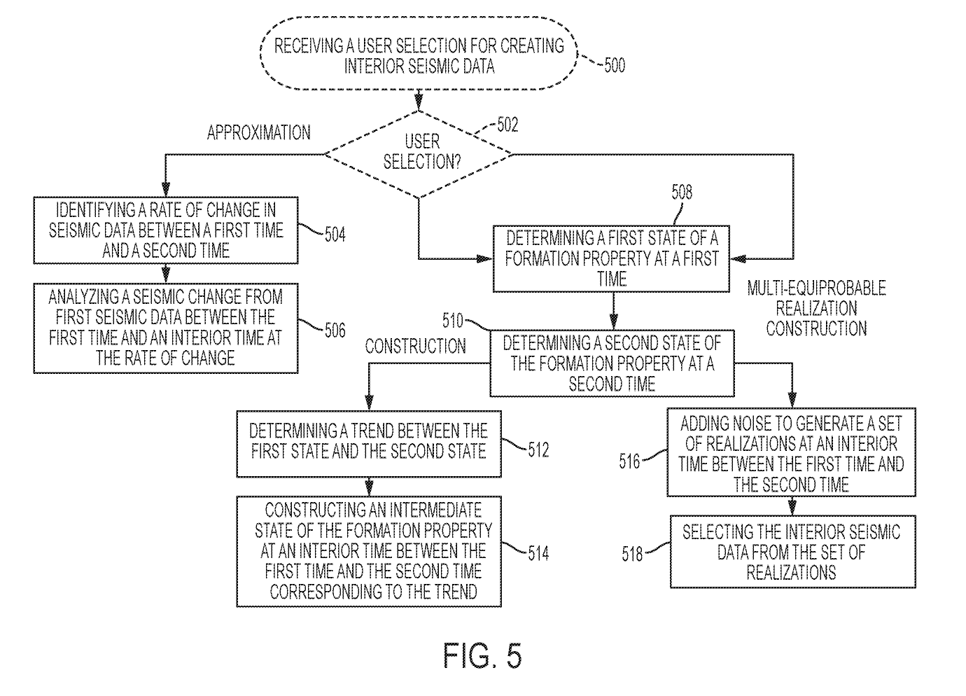

FIGS. 4 and 5 are flow charts illustrating examples of processes that may be used to create interior seismic data. The processes are described with respect to the wellbore environments of FIGS. 1 and 2 and the system of FIG. 3 unless otherwise indicated, although other implementations are possible without departing from the scope of the present disclosure.

FIG. 4 is a flow chart of an example of a process for creating and using interior seismic data according to an aspect of the present disclosure. In block 400, first seismic data 304 is received corresponding to data generated by the sensors 122 of the seismic tool 118. The first seismic data may correspond to a time that the measurement was sampled by the sensors 122. In some aspects, the first seismic data 304 is received by the data acquisition unit 128. In additional aspects, the first seismic data 304 is received by the computing device 306. The computing device 306 may receive the first seismic data 304 via the network 308 from the data acquisition unit 128. In some aspects, the first seismic data 304 may be received as unprocessed data. In other aspects, the first seismic data 304 may be received as processed data, or as a combination of unprocessed and processed data. For example, the first seismic data 304 may be received as a processed image generated from the data acquired by 222 and representing one or more properties of an area of the formations 112 adjacent to a wellbore 108.

In block 402, additional seismic data 304 is received corresponding to data generated by the sensors 122 of the seismic tool 118 at a different time. In some aspects, the data acquisition unit 128 or the computing device 306 may receive the additional seismic data 304 at a time subsequent to the time that the seismic data 304 described in block 400 was received. For example, the seismic tool 118 may be configured to generate the seismic data at regular sampling intervals (months, years, etc.). Similar to the first seismic data 304, the additional seismic data 304 may be received as unprocessed data, processed data, or as a combination of unprocessed and processed data. In some aspects, the seismic data 304 of blocks 400, 402 may be received by the computing device 306 simultaneously. For example, the seismic data 304 corresponding to each sample may be stored in the storage device 302 of the data acquisition unit 128 and transmitted to the computing device 306 in batches subsequent to multiple intervals of sampling the seismic data 304. In other aspects, the seismic data 304 may be transmitted to the computing device 306 subsequent to each sampling by the seismic tool 118.

In block 404, the computing device 306 creates interior seismic data for one or more times between the time associated with the first seismic data 304 and the additional seismic data 304 acquired at a later instance of time. In some aspects, the computing device 306 may facilitate creating the interior seismic data using one of a number of sub-processes. In additional aspects, the seismic data 304 may include the formation properties associated with an inversion of the seismic data 304. For example, the computing device 306 may calculate an inversion of the seismic data 304 to identify the formation properties associated with the seismic data 304 and use the formation property information in a sub-process for creating the interior seismic data. The interior seismic data may be determined from the analysis of the formation properties associated with the seismic data 304 by convoluting a wavelet of the seismic data 304 with the formation properties to get a seismic response.

In some aspects, the velocity between the first seismic data and the additional seismic data may be accurate to allow the volumes of the seismic data 304 in the depth-domain to register. In other aspects, changes in the structure of the rock properties associated with the seismic data (e.g., compaction or subsidence between the first seismic data and the additional seismic data) may occur. The computing device 306 may create the interior seismic data by shifting the seismic data 304. In one example, the volumes of seismic data 304 may include vertical axes (relative to the surface 104) in the time-domain corresponding to the travel time of the seismic waves 124 to the area of interest in the subterranean formation 112. A warping function corresponding to the time delay between the volume of first seismic data and the volume of additional seismic data may be determined manually or automatically using known methods (e.g., dynamic time-warping, cross-correlation, etc.) to shift the seismic data 304. The warping function or time delay may be applied to the first seismic data, the additional seismic data, or both. In other example, the volumes of seismic data 304 may include vertical axes in the depth-domain corresponding to the depth of the area of interest in the subterranean formation 112 from the surface 104. A warping function corresponding to the depth delay between the volumes of first seismic data and additional seismic data may be determined and applied to one or both of the first seismic data or the additional seismic data. In some aspects, the computing device 306 may create the interior seismic data by shifting the seismic data prior to creating the interior seismic data to allow the volumes of seismic data to occupy the same special location.

FIG. 5 is a flow chart of examples of sub-processes for creating interior seismic data according to an aspect of the present disclosure. FIG. 5 describes processes for creating interior seismic data using the seismic data received in blocks 400, 402 of FIG. 4. The sub-processes include an approximation sub-process, a construction sub-process, and a multi-equi-probable realization (“MEPR”) construction sub-process. The sub-processes are described as being implemented in response to a selection of one of the processes by a user. But, these steps may be optional as indicated by dashed blocks 500, 502.

In block 500, a selection for creating the interior seismic data may be received from a user of the computing device 306. In some aspects, the user selection may be received by the computing device 306 in response to a selection of a selection tool included on a user interface generated by the computing device 306. For example, the computing device 306 may generate one or more user interfaces including selection tools corresponding to each of a number of sub-processes for creating interior seismic data. A user of the computing device 306 may use hardware connected to the computing device (e.g., a keyboard, a mouse, a touchpad, etc.) to select a selection tool displayed on the user interface corresponding to a desired sub-process for creating the interior seismic data. In some aspects, the computing device 306 may generate a selection signal corresponding to the selection by the user and transmit the selection signal to the processing device 314.

In block 502, the computing device 306 may determine which sub-process for creating the interior seismic data was selected by the user. In some aspects, the computing device 306 may determine the sub-process based on a selection signal corresponding to the selection and indicating the appropriate instructions 320 for executing the sub-process. Although the sub-processes for creating the interior seismic data is described in FIG. 5 as performed in response to a user selection of the sub-process, each sub-process may be performed by the computing device 306 independent of the user selection described in the optional steps of blocks 500, 502.

Blocks 504 through 506 describe a sub-process for creating interior data by approximation. In block 504, a rate of change in the seismic data 304 within the period between the times associated with the measurements of the first seismic data 304 and the additional seismic data 304 described in blocks 400, 402 of FIG. 4. In some aspects, the computing device 306 may analyze the seismic data 304 and changes in the properties of the area of the formations 112 from the first seismic data 304 to the additional seismic data 304. The rate of the change may be identified by dividing the changes determined between the first seismic data 304 and the additional seismic data 304 by the times associated with the measurement of the seismic data 304 by the sensors 122 of the seismic tool 118. For example, the processing device 314 may execute instructions 320, including Equation 2, to calculate a rate of change based on the changes in the seismic data 304 over the time between sampling of the first seismic data 304 and the additional seismic data 304.

In block 506, a seismic change may be analyzed from the first seismic data to predetermined time between the time associated with the first seismic data 304 and the time associated with the additional seismic data 304. In some aspects, the computing device 306 may allow a user to select a time between the times associated with the seismic data 304. For example, the first seismic data 304 may be collected by the seismic tool 118 on the first day of Month 1 and the additional seismic data 304 may be collected on the first day of Month 2. The computing device 306 may generate user interfaces having selection tools for inputting or selecting a time between Month 1 and Month 2 (e.g., the 15th day of Month 1, the first day of the second week of Month 1) as an interior time for creating the interior seismic data. The computing device 306 may initiate a change in the seismic data 304 from the first seismic data at the rate of change in the properties of the formations 112 associated with the seismic data 304. The computing device 306 may stop the changing of the first seismic data 304 at the rate of change once the selected interior time is reached using, for example, Equation 1. In other aspects, the computing device 306 may automatically create interior seismic data at an interior time. For example, the computing device 306 may generate interior seismic data corresponding to each week of Month 1. In some aspects, the time interval for the interior times may be selected by the user.

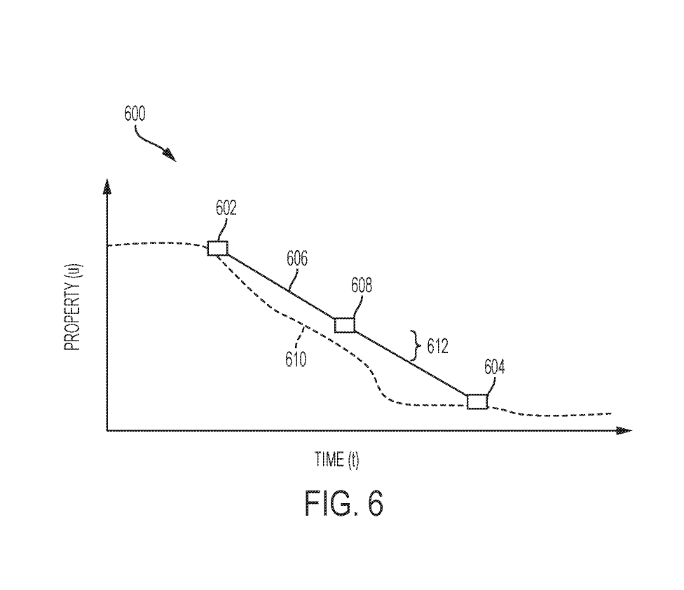

FIG. 6 is an example of a graph 600 generated using the approximation sub-process described in FIG. 5 according to some aspects of the present disclosure. Point 602 represents the seismic data 304 received as described in block 400 of FIG. 4. Point 604 represents the additional seismic data 304 received as described in block 402. The rate of change between the seismic data 304 and the additional seismic data 304 is illustrated by profile 606. In some aspects, the rate of change may be constant or linear, resulting in the profile 606 as a straight line between the points 602, 604. Point 608 represents interior seismic data at a time between the times associated with the points 602, 604. Additional interior seismic data may be determined at additional times between the times associated with points 602, 605 to create additional seismic data along the profile 606.

Profile 610 represents an example of the actual changes in the properties of the area of the formations 112 associated with the seismic data 304 over time. As indicated by the gap 612 between the profiles 606, 610, there may be error in the interior seismic data created using the approximation process of FIG. 5. The size of the gap 612 and the associated error in approximating the interior seismic data at point 608 may correspond to the frequency of the samples of seismic data corresponding to point 602, 604. For example, where the seismic data 304 is sampled in hours or days, the error may be less than a less frequent sampling of the seismic data 304 (e.g., months, years). But, the error may be an acceptable error for purposes of creating the interior seismic data.

Returning to FIG. 5, blocks 508 through 514 describe a sub-process for creating interior seismic data by construction. In block 508, a state of a property of the formations 112 associated with the first seismic data 304 is determined. In some aspects, the computing device 306 may determine the state of the formations 112 based on spatial and temporal attributes of the properties of the formations 112. For example, the computing device 306 may analyze a position of rocks in an area of the formations 112 and the time at which the seismic data for the area of the formations 112 was sampled. The computing device 306 may determine a relationship between the position of the rock formation in the area and the time at which the rocks were observed in the position for comparison with the relationship between a new position of the rock formation at a different time. In block 510, a state of a property of the formations 112 associated with the additional seismic data 304 is determined. In some aspects, the computing device 306 may determine the state of the same formations 112 based on the relationship of the same properties (e.g., a location of the same rocks) and a new time associated with the sampling of the additional seismic data.

In block 512, a trend between the first state and the second state is determined. In some aspects, the trend may be determined by comparing the spatio-temporal relationship associated with the seismic data 304 observed as described in block 508 and the spatio-temporal relationship associated with the additional seismic data 304 observed as described in block 510. In some aspects, a spatio-temporal variogram may be computing using instructions 320 stored in the memory device 318 (e.g., Equation 3) to produce a variance of data between the two measurements of the seismic data 304 to identify or choose a trend. In some examples, a linear trend may be determined where the relationship between the state of the formations 112 and the sample time is consistent between the two samples. In some aspects, the additional seismic data 304 may include additional samples (e.g., providing a total of three or more samples of the seismic data 304) to cause the trend to be updated in response to the additional samples. For example, two samples of seismic data 304 may yield a linear trend, but observing the three or more samples collectively may yield a new trend (e.g., exponential, parabolic, etc.).

In block 514, an intermediate state of the property of the formations 112 associated with the seismic data 304 is constructed for an interior time between the times associated with the sampling of the first seismic data 304 and the additional seismic data 304. In some aspects, an intermediate state of the same property of the formations 112 may be constructed corresponding to the trend. In some aspects, the intermediate state may be constructed using interpolation methods associated with the trend. For example, equations corresponding to a Kriging interpolation method, including a linear unbiased predictor (e.g., Equation 4) or other prediction equation (e.g., Equation 5) accounting for the spatial and temporal attributes of the seismic data 304 to predict the intermediate state of the formations 112 between the times associated with the samples of seismic data 304. For examples, where the additional seismic data 304 includes multiple samples of seismic data 304, the intermediate state may be modified in response to an updated trend associated with the collective observation of the samples of seismic data 304.

In some aspects, the graph 600 of FIG. 6, although generated based on the approximation method of FIG. 5, may illustrate an example of the interior seismic data created using the construction sub-process of FIG. 5. For example, when a trend is determined using only two samples of seismic data 304, the identified trend may be a linear trend between the samples. The linear trend may correspond to the constant rate of change in the properties of the formations 112 associated with the seismic data 304 as indicated by the profile 606. The linear trend may produce interior seismic data for interior times between the times of the measurements similar or identical to the interior seismic data created using the approximation method of FIG. 5.

Returning to FIG. 5, blocks 516 through 518, preceded by blocks 508 through 510, describe a sub-process for creating interior seismic data by multi-equi-probable realization construction. The multi-equi-probable realization construction sub-process is initiated with the same steps for creating the interior seismic data by construction as described in blocks 508 and 510. In block 516, Gaussian white noise is added to a linear prediction of interior seismic data. The Gaussian white noise may include a statistical noise corresponding to recognized amounts of unexplained variations in the samples of the seismic data 304. The noise may include a normal distribution. In some aspects, the Gaussian white noise may correspond to uncertainties in the rock properties visualized or otherwise calculated from the seismic data 304. Non-limiting examples of the uncertainties that may be represented by the Gaussian white noise may include a characterization of fluid flow in the area of the formations 112, a petro-elastic relationship between the flow and the rock properties during a production phase of a wellbore operation, fluid-rock interactions, geo-mechanical phenomena, and time shifting in the seismic data 304.

Adding the Gaussian white noise to linear prediction of the interior seismic data may be done using known methods (e.g., a Sequential Gaussian Simulation, normal distribution) to generate a set of equi-probable interior seismic realization data points between the sample times of the seismic data 304. Each potential realization at the interior time may be equally likely to be the correct construction of the interior seismic data based on different effects of the uncertainty in the properties of the formations 112 represented by the Gaussian white noise.

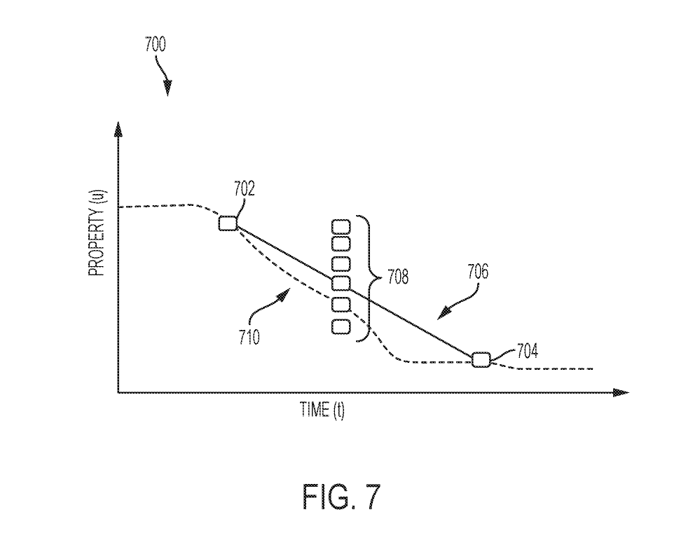

FIG. 7 is an example of a graph 700 generated using the multi-equi-probable realization construction sub-process of FIG. 5 according to some aspects of the present disclosure. Point 702 represents the seismic data 304 received as described in block 400 of FIG. 4. Point 704 represents the additional seismic data 304 received as described in block 402. Profile 706 represents one of the rate of change between the seismic data 304 and the additional seismic data 304 determined using the approximation sub-process of FIG. 5 or a trend line determined using the construction sub-process of FIG. 5. The set of points 608 represent equi-probable realizations of the interior seismic data at a time between the times associated with the points 702, 704. Profile 710 represents an example of the actual changes in the properties of the area of the formations 112 associated with the seismic data 304 over time. As indicated by the set of points 708, the potential interior seismic data may be determined for points along the property axis for the same interior time, including potential points corresponding to the profile 706 and the profile 710.

Returning to FIG. 5, in block 518, the interior seismic data from the set of potential seismic data is selected. The interior seismic data may correspond to the point in the set of points 708 of FIG. 7 overlapping with the profile 710 representing the actual change in the properties of the area of the formations 112. In some aspects, the interior seismic data may be selected by comparing the potential seismic data to petro-elastic models derived from simulations representing the potential fluid flow through the area of the formations 112 corresponding to the seismic data 304. For example, the potential seismic data may be quantitatively co-analyzed and qualitatively co-visualized with results of a flow simulation using instructions 320 (e.g., Equations 5 and 6) to identify the realization of the interior seismic data closely resembling (e.g., creating synergy with) the petro-elastic model derived from simulation. For purposes of continuity between space and time, the flow simulations may be modeled by numerical methods where a physical domain of dependence exists within the numerical domain of dependence. This may allow for the numerical flow simulation of the area over the same time as the seismic data 304 sample intervals to be co-analyzed and calibrated by the acquired and interior predicted seismic data.

Returning to the process of FIG. 4, subsequent to creating the interior seismic data as described in block 404 (and the sub-processes described in FIG. 5), the computing device 306 may be configured to use the interior seismic data. The process of FIG. 4 includes additional optional steps for using the interior seismic data created in block 404. The optional steps are indicated by the dashed blocks 406, 408. In block 406, the computing device 306 may generate an animation of changes or co-analyze changes in seismic data with recorded production at greater frequency in the formations 112 corresponding to the seismic data 304 using the seismic data received in blocks 400, 402 and the interior seismic data created in block 404. In some aspects, the processing device 314 may execute instructions 320 to generate seismic or rock property animations using the stored seismic data 304 and the determined interior seismic data by displaying the seismic data 304 and the interior seismic data in order of time associated with the data at a rate to create the animation. In some aspects, the animation may be displayed on the display unit 322.

In some aspects, the interior seismic data and the associated animation may be displayed in the time-domain. For example, dynamic time-warping or cross-correlation methods may be used to identify time shifts between different vintages of seismic data 304 and the interior seismic. The computing device 306 may use the time shifts as an additional property in the sub-processes described in FIG. 5 or to warp the intermediate volumes associated with the interior seismic data. In some aspects, the time-shifted seismic data may be viewed as an animation and coupled with production information or other data sources that may provide data related to the time-domain pull-up or pull-down associated with the formations 112.

In block 408, the computing device 306 may compare the interior seismic data to a petro-elastic model derived from flow simulation. In some aspects, comparing the interior seismic data to the flow simulation model may be performed as described in block 518 of FIG. 5. In some aspects, the interior seismic data and the petro-elastic model derived from flow simulation may be compared to validate the accuracy of the interior seismic data. For example, the process for creating the interior seismic data may include multiple potential data points corresponding to the interior seismic data, as described in the multi-equi-probable realization construction sub-process of FIG. 5. Comparing the interior seismic data and the petro-elastic model derived from a flow simulation results may allow the closest or most accurate interior seismic data to be selected from the potential data points as described in block 518 of FIG. 5. In additional and alternative aspects, the interior seismic data and the petro-elastic model derived from flow simulation results may be compared to calibrate the petro-elastic model. For example, the results of the flow simulation may be adjusted to correspond to the properties of the formations 112 shown in interior seismic data at the interior time associated with the interior seismic data. The additional seismic data created by the interior seismic data between the actual samples of seismic data 304 may allow for increased calibration of the simulation model for more accurate numerical flow simulations of the fluid flow through the formations 112.

In some aspects, interior seismic data may be created according to one or more of the following examples:

Example #1: A method may include receiving first seismic data of an area of a subterranean formation and associated with a first instance of time. The method may also include receiving second seismic data of the area of the subterranean formation and associated with a second instance of time. The method may also include using the first seismic data and the second seismic data to create seismic data for one or more interior times between the first instance of time and the second instance of time, the seismic data representing changes in at least one property of the subterranean formation.

Example #2: The method of Example #1 may feature using the first seismic data and the second seismic data to create the seismic data to include analyzing a first seismic change in the area of the subterranean formation between the first seismic data and the second seismic data over a first time interval from the first instance of time to the second instance of time to identify a rate of seismic change. The method may also feature creating the seismic data by determining a second seismic change in the area of the subterranean formation initiating from the first seismic data and occurring over a second time interval between the first instance of time and an interior instance of time at the rate of seismic change, the interior instance of time being between the first instance of time and the second instance of time. The method may also feature the second instance of time being subsequent to the first instance of time.

Example #3: The method of Example #1 may feature using the first seismic data and the second seismic data to create the seismic data to include observing the first seismic data to determine a first state of the at least one property of the subterranean formation at the first instance of time. The method may also feature observing the second seismic data to determine a second state of the at least one property of the subterranean formation at the second instance of time, the second instance of time being subsequent to the first instance of time. The method may also feature determining a trend between the first state and the second state. The method may also feature constructing an intermediate state of the at least one property of the subterranean formation at an interior time between the first instance of time and the second instance of time corresponding to the trend.

Example #4: The method of Examples #1-3 may include receiving third seismic data of the area of the subterranean formation and associated with a third time, the third time being subsequent to the second instance of time. The method may also include observing the third seismic data to determine a third state of the at least one property of the subterranean formation at the third time. The method may also include determining an updated trend between the first state, the second state, and the third state. The method may also include modifying the seismic data at the interior time corresponding to the updated trend.

Example #5: The method of Example #1 may feature using the first seismic data and the second seismic data to create the seismic data to include observing the first seismic data to determine a first state of the at least one property of the subterranean formation at the first instance of time. The method may also feature observing the second seismic data to determine a second state of the at least one property of the subterranean formation at the second instance of time, the second instance of time being subsequent to the first instance of time. The method may also feature adding Gaussian white noise to a linear prediction of the seismic data between the first seismic data and the second seismic data to generate a set of equi-probable realizations of the linear prediction of the seismic data at an interior instance of time between the first instance of time and the second instance of time. The method may also feature selecting the seismic data from the set of equi-probable realizations.

Example #6: The method of Example #5 may feature selecting the seismic data from the set of equi-probable realizations to include comparing one or more realizations in the set of equi-probable realizations to a petro-elastic model derived from a simulation of fluid flowing within the area of the subterranean formation between the first instance of time and the second instance of time and selecting a realization of the one or more realizations resembling the petro-elastic model.

Example #7: The method of Examples #1-6 may also include generating an animation using the first seismic data associated with the first instance of time, the second seismic data associated with the second instance of time, and the seismic data for the one or more interior times between the first instance of time and the second instance of time.

Example #8: The method of Examples #1-7 may also feature using the seismic data to calibrate a simulation of fluid flowing within the area of the subterranean formation between the first instance of time and the second instance of time.

Example #9: The method of Examples #1-8 may also feature verifying the seismic data by comparing the seismic data to a petro-elastic model derived from a simulation of fluid flowing within the area of the subterranean formation between the first instance of time and the second instance of time.

Example #10: The method of Examples #1-9 may feature the first seismic data and the second seismic data including seismic volumes in a time-domain. The method may also feature using the first seismic data and the second seismic data to create the seismic data for the one or more interior times to include determining a time delay and applying the time delay to the first seismic data or the second seismic data to create the seismic data for the one or more interior times.

Example #11: The method of Examples #1-9 may feature the first seismic data and the second seismic data including seismic volumes in a depth-domain. The method may also feature using the first seismic data and the second seismic data to create the seismic data for the one or more interior times to include determining a depth delay and applying the depth delay to the first seismic data or the second seismic data to create the seismic data for the one or more interior times.

Example #12: A system may include a computing device including a processing device. The computing device may also include a memory device in which instructions executable by the processing device are stored for causing the processing device to create seismic data for one or more interior instances of time between a first instance of time and a second instance of time using sampled seismic data collected at the first instance of time and the second instance of time, the seismic data representing changes in at least one property of an area of a subterranean formation.

Example #13: The system of claim Example #12 may feature the memory device further including instructions executable by the processing device for causing the processing device to create the seismic data by identifying a rate of seismic change corresponding to a first seismic change in the sampled seismic data for the area of the subterranean formation from the first instance of time to the second instance of time, and determining a second seismic change initiating from the sampled seismic data at the first instance of time to an interior time between the first instance of time and the second instance of time at the rate of seismic change. The system may feature the second instance of time being subsequent to the first instance of time.

Example #14: The system of Example #12 may feature the memory device further including instructions executable by the processing device for causing the processing device to create the seismic data by observing the sampled seismic data to determine a first state and a second state of the at least one property of the area of the subterranean formation at the first instance of time and the second instance of time, the second instance of time being subsequent to the first instance of time. The system may feature the memory device further including instructions executable by the processing device for causing the processing device to create the seismic data by determining a trend between the first state and the second state. The system may feature the memory device further including instructions executable by the processing device for causing the processing device to create the seismic data by constructing an intermediate state of the at least one property of the area of the subterranean formation at an interior instance of time between the first instance of time and the second instance of time corresponding to the trend.

Example #15: The system of Examples #12-14 may feature the memory device including additional instructions executable by the processing device for causing the processing device to determine a third state of the at least one property of the subterranean formation at a third time using additional seismic data. The system may also feature the memory device including additional instructions executable by the processing device for causing the processing device to determine an updated trend between the first state, the second state, and the third state. The system the memory device including additional instructions executable by the processing device for causing the processing device to modify the seismic data at the interior instance of time corresponding to the updated trend.

Example #16: The system of Example #12 may feature the memory device further including instructions executable by the processing device for causing the processing device to create the seismic data by observing the sampled seismic data to determine a first state and a second state of the at least one property of the area of the subterranean formation at the first instance of time and the second instance of time, the second instance of time being subsequent to the first instance of time. The system the memory device including additional instructions executable by the processing device for causing the processing device to create the seismic data by adding Gaussian white noise to a linear prediction of the seismic data between the sampled seismic data to generate a set of equi-probable realizations of the linear prediction of the seismic data at an interior instance of time between the first instance of time and the second instance of time. The system the memory device including additional instructions executable by the processing device for causing the processing device to create the seismic data by selecting the seismic data from the set of equi-probable realizations.

Example #17: The system of Examples #12-16 may feature, wherein the memory device comprises additional instructions executable by the processing device for causing the processing device to select the seismic data from the set of equi-probable realizations by comparing one or more data points in the set of equi-probable realizations to a petro-elastic model derived from a simulation of fluid flowing within the area of the subterranean formation between the first instance of time and the second instance of time and selecting the one or more data points resembling the petro-elastic model.

Example #18: The system of Examples #12-17 may also include a display unit couplable to the computing device. The system may feature the memory device further including instructions executable by the processing device for causing the processing device to generate an animation using the sampled seismic data and the seismic data for the one or more interior instances of time between the first instance of time and the second instance of time.

Example #19: The system of Examples #12-18 may feature the memory device further including instructions executable by the processing device for causing the processing device to compare the seismic data for the one or more interior instances of time between the first instance of time and the second instance of time to a petro-elastic model derived from a simulation of fluid flowing within the area of the subterranean formation between the first instance of time and the second instance of time.

Example #20: A system may include a seismic tool positionable proximate to an area of subterranean formation to generate first seismic data corresponding to the area of the subterranean formation at a first instance of time and second seismic data corresponding to the area of the subterranean formation at a second instance of time. The system may also include a seismic source positionable to generate seismic waves detectable by one or more sensors of the seismic tool. The system may also include a computing device including a processing device for which instructions executable by the processing device are used to cause the processing device to create seismic data for one or more interior instances of time between the first instance of time and the second instance of time using sampled seismic data collected at the first instance of time and the second instance of time, the seismic data representing changes in at least one property of the area of a subterranean formation.

Example #21: The system of Example #20 may also include a display unit couplable to the computing device. The system may feature the memory device further including instructions executable by the processing device for causing the processing device to generate an animation using the sampled seismic data and the seismic data for the one or more interior instances of time between the first instance of time and the second instance of time. The system may feature the second instance of time being subsequent to the first instance of time.

Example #22: The system of Examples #20-21 may further include a data acquisition unit couplable to the seismic tool. The system may also feature the data acquisition unit including a storage device for storing the sampled seismic data for use by the computing device.

The foregoing description of the examples, including illustrated examples, has been presented only for the purpose of illustration and description and is not intended to be exhaustive or to limit the subject matter to the precise forms disclosed. Numerous modifications, adaptations, uses, and installations thereof can be apparent to those skilled in the art without departing from the scope of this disclosure. The illustrative examples described above are given to introduce the reader to the general subject matter discussed here and are not intended to limit the scope of the disclosed concepts.

What is claimed is:

1. A method comprising:
receiving first seismic data of an area of a subterranean formation and associated with a first instance of time;
receiving second seismic data of the area of the subterranean formation and associated with a second instance of time; and
using the first seismic data and the second seismic data to create seismic data for one or more interior times between the first instance of time and the second instance of time, the seismic data representing changes in at least one property of the subterranean formation.

2. The method of claim 1, wherein using the first seismic data and the second seismic data to create the seismic data includes:
analyzing a first seismic change in the area of the subterranean formation between the first seismic data and the second seismic data over a first time interval from the first instance of time to the second instance of time to identify a rate of seismic change; and
creating the seismic data by determining a second seismic change in the area of the subterranean formation initiating from the first seismic data and occurring over a second time interval between the first instance of time and an interior instance of time at the rate of seismic change, the interior instance of time being between the first instance of time and the second instance of time,
wherein the second instance of time is subsequent to the first instance of time.

3. The method of claim 1, wherein using the first seismic data and the second seismic data to create the seismic data includes:
observing the first seismic data to determine a first state of the at least one property of the subterranean formation at the first instance of time;
observing the second seismic data to determine a second state of the at least one property of the subterranean formation at the second instance of time, the second instance of time being subsequent to the first instance of time;
determining a trend between the first state and the second state; and
constructing an intermediate state of the at least one property of the subterranean formation at an interior time between the first instance of time and the second instance of time corresponding to the trend.

4. The method of claim 3, further including:
receiving third seismic data of the area of the subterranean formation and associated with a third time, the third time being subsequent to the second instance of time;
observing the third seismic data to determine a third state of the at least one property of the subterranean formation at the third time;
determining an updated trend between the first state, the second state, and the third state; and
modifying the seismic data at the interior time corresponding to the updated trend.

5. The method of claim 1, wherein using the first seismic data and the second seismic data to create the seismic data includes:
observing the first seismic data to determine a first state of the at least one property of the subterranean formation at the first instance of time;
observing the second seismic data to determine a second state of the at least one property of the subterranean formation at the second instance of time, the second instance of time being subsequent to the first instance of time;
adding Gaussian white noise to a linear prediction of the seismic data between the first seismic data and the second seismic data to generate a set of equi-probable realizations of the linear prediction of the seismic data at an interior instance of time between the first instance of time and the second instance of time; and
selecting the seismic data from the set of equi-probable realizations.

6. The method of claim 5, wherein selecting the seismic data from the set of equi-probable realizations includes comparing one or more realizations in the set of equi-probable realizations to a petro-elastic model derived from a simulation of fluid flowing within the area of the subterranean formation between the first instance of time and the second instance of time and selecting a realization of the one or more realizations resembling the petro-elastic model.

7. The method of claim 1, further comprising generating an animation using the first seismic data associated with the first instance of time, the second seismic data associated with the second instance of time, and the seismic data for the one or more interior times between the first instance of time and the second instance of time.

8. The method of claim 1, further comprising using the seismic data to calibrate a simulation of fluid flowing within the area of the subterranean formation between the first instance of time and the second instance of time.

9. The method of claim 1, further comprising verifying the seismic data by comparing the seismic data to a petro-elastic model derived from a simulation of fluid flowing within the area of the subterranean formation between the first instance of time and the second instance of time.

10. The method of claim 1, wherein the first seismic data and the second seismic data include seismic volumes in a time-domain,
wherein using the first seismic data and the second seismic data to create the seismic data for the one or more interior times includes determining a time delay and applying the time delay to the first seismic data or the second seismic data to create the seismic data for the one or more interior times.

11. The method of claim 1, wherein the first seismic data and the second seismic data include seismic volumes in a depth-domain,
wherein using the first seismic data and the second seismic data to the create seismic data for the one or more interior times includes determining a depth delay and applying the depth delay to the first seismic data or the second seismic data to create the seismic data for the one or more interior times.

12. A system, comprising:
a computing device, comprising:
a processing device; and
a memory device in which instructions executable by the processing device are stored for causing the processing device to create seismic data for one or more interior instances of time between a first instance of time and a second instance of time using sampled seismic data collected at the first instance of time and the second instance of time, the seismic data representing changes in at least one property of an area of a subterranean formation.

13. The system of claim 12, wherein the memory device further comprises instructions executable by the processing device for causing the processing device to create the seismic data by identifying a rate of seismic change corresponding to a first seismic change in the sampled seismic data for the area of the subterranean formation from the first instance of time to the second instance of time, and determining a second seismic change initiating from the sampled seismic data at the first instance of time to an interior time between the first instance of time and the second instance of time at the rate of seismic change,
wherein the second instance of time is subsequent to the first instance of time.

14. The system of claim 12, wherein the memory device further comprises instructions executable by the processing device for causing the processing device to create the seismic data by:
observing the sampled seismic data to determine a first state and a second state of the at least one property of the area of the subterranean formation at the first instance of time and the second instance of time, the second instance of time being subsequent to the first instance of time;
determining a trend between the first state and the second state; and
constructing an intermediate state of the at least one property of the area of the subterranean formation at an interior instance of time between the first instance of time and the second instance of time corresponding to the trend.

15. The system of claim 14, wherein the memory device comprises additional instructions executable by the processing device for causing the processing device to:
determine a third state of the at least one property of the subterranean formation at a third time using additional seismic data;
determine an updated trend between the first state, the second state, and the third state; and
modify the seismic data at the interior instance of time corresponding to the updated trend.

16. The system of claim 12, wherein the memory device further comprises instructions executable by the processing device for causing the processing device to create the seismic data by:
observing the sampled seismic data to determine a first state and a second state of the at least one property of the area of the subterranean formation at the first instance of time and the second instance of time, the second instance of time being subsequent to the first instance of time;
adding Gaussian white noise to a linear prediction of the seismic data between the sampled seismic data to generate a set of equi-probable realizations of the linear prediction of the seismic data at an interior instance of time between the first instance of time and the second instance of time; and
selecting the seismic data from the set of equi-probable realizations.

17. The system of claim 16, wherein the memory device comprises additional instructions executable by the processing device for causing the processing device to select the seismic data from the set of equi-probable realizations by comparing one or more data points in the set of equi-probable realizations to a petro-elastic model derived from a simulation of fluid flowing within the area of the subterranean formation between the first instance of time and the second instance of time and selecting the one or more data points resembling the petro-elastic model.

18. The system of claim 12, further comprising:
a display unit couplable to the computing device,
wherein the memory device further comprises instructions executable by the processing device for causing the processing device to generate an animation using the sampled seismic data and the seismic data for the one or more interior instances of time between the first instance of time and the second instance of time.

19. The system of claim 12, wherein the memory device further comprises instructions executable by the processing device for causing the processing device to compare the seismic data for the one or more interior instances of time between the first instance of time and the second instance of time to a petro-elastic model derived from a simulation of fluid flowing within the area of the subterranean formation between the first instance of time and the second instance of time.

20. A system, comprising:
a seismic tool positionable proximate to an area of subterranean formation to generate first seismic data corresponding to the area of the subterranean formation at a first instance of time and second seismic data corresponding to the area of the subterranean formation at a second instance of time;
a seismic source positionable to generate seismic waves detectable by one or more sensors of the seismic tool; and
a computing device including a processing device for which instructions executable by the processing device are used to cause the processing device to create seismic data for one or more interior instances of time between the first instance of time and the second instance of time using sampled seismic data collected at the first instance of time and the second instance of time, the seismic data representing changes in at least one property of the area of a subterranean formation.

21. The system of claim 20, further comprising:
a display unit couplable to the computing device,
a memory device comprising instructions executable by the processing device for causing the processing device to generate an animation using the sampled seismic data and the seismic data for the one or more interior instances of time between the first instance of time and the second instance of time,
wherein the second instance of time is subsequent to the first instance of time.

22. The system of claim 20, further comprising:
a data acquisition unit couplable to the seismic tool, the data acquisition unit including a storage device for storing the sampled seismic data for use by the computing device.
